(19) United States
(12) Patent Application Publication
(10) Pub. No.: US 2022/0099212 A1
(43) Pub. Date: Mar. 31, 2022

(54) ELECTROMAGNETIC VALVE

(71) Applicant: Nidec Tosok Corporation, Zama-shi (JP)

(72) Inventor: Tomohiko NAKANISHI, Zama-shi (JP)

(21) Appl. No.: 17/481,368

(22) Filed: Sep. 22, 2021

(30) Foreign Application Priority Data
Sep. 30, 2020 (JP) 2020-165776

(51) Int. Cl. F16K 31/06

(52) U.S. Cl. CPC F16K 31/0675; F16K 31/0655

(57) ABSTRACT

An electromagnetic valve includes a solenoid with a bobbin, a plunger, a yoke, and a coil, a flow path assembly including a first flow path, a second flow path, and a valve housing portion, and a valve that switches between an open state and a closed state between the first flow path and the second flow path. The plunger includes a passage that extends along an axial direction, and that opens toward another axial side to communicate with a gap between the plunger and the yoke, and an opening that opens radially outward from the passage to allow the passage communicating with the gap to communicate with the valve housing portion through the passage. The electromagnetic valve further includes a regulator to regulate a radially outward flow of a fluid flowing out from the passage into the gap at least in the open state.

### CROSS-REFERENCE TO RELATED APPLICATIONS

The present application claims priority under 35 U.S.C. § 119 to Japanese Patent Application No. 2020-165776, filed on Sep. 30, 2020, the entire contents of which are hereby incorporated herein by reference.

### FIELD OF THE INVENTION

The present disclosure relates to an electromagnetic valve.

### BACKGROUND

Electromagnetic valves are known in which a flow of fluid such as gas, or water or oil, is switched, or passage and interruption of the fluid are switched. Each of conventional electromagnetic valves can be mounted on, for example, a vehicle including an internal combustion engine such as an engine. When mounted on a vehicle, an electromagnetic valve can be used for switching between passage and interruption of a blow-by gas.

One of the conventional electromagnetic valves includes a guide portion in a tubular shape, a plunger movably supported in the guide portion, and a valve element that is fixed to the plunger, and that opens and closes a fluid passage as the plunger moves.

The other of the conventional electromagnetic valves includes a plunger housing portion in an octagonal tubular shape in cross section, a plunger that is movably (slidably) housed in the plunger housing portion, and a valve element that is fixed to the plunger, and that opens and closes a flow path as the plunger moves.

One of the conventional electromagnetic valves is configured such that the plunger is provided with a through-hole (a vent hole passage and a vent passage) allowing the inside of the guide portion to communicate with the fluid passage. The blow-by gas may contain impurities such as dust called contamination, and the impurities may pass through the through-hole of the plunger from the fluid passage to enter between the guide portion and the plunger. In this case, the impurities may hinder smooth movement of the plunger.

The other of the conventional electromagnetic valve has a gap (clearance) generated between an inner peripheral portion of the plunger housing portion and an outer peripheral portion of the plunger, and thus may cause smooth movement of the plunger to be hindered when the impurities enter the gap.

### SUMMARY

An electromagnetic valve according to an example embodiment of the present disclosure includes a solenoid including a bobbin with a tubular shape including a through-hole passing through the bobbin along an axial direction, a plunger that is inserted in the through-hole on one axial side, and that is movably supported along the axial direction, a yoke that is inserted in the through-hole on another axial side, and that is fixed to the bobbin, and a coil that is wound around an outer peripheral portion of the bobbin, and that generates a magnetic force with energization to move the plunger in the axial direction, a flow path assembly that includes a first flow path, a second flow path, and a valve housing portion provided with a tubular space communicating with the first flow path and the second flow path, and that is coupled to the solenoid, and a valve that is housed in the valve housing portion and fixed to the plunger on the one axial side, and that moves together with the plunger along the axial direction to switch between an open state and a closed state between the first flow path and the second flow path, the plunger includes a passage that extends along the axial direction and opens toward another axial side, and that communicates with a gap between the plunger and the yoke, and an opening that opens radially outward from the passage, and that communicates with the gap through the passage, the electromagnetic valve further including a regulator to regulate a radially outward flow of a fluid flowing out from the passage to the gap at least in the open state.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram illustrating an example of a use state of an electromagnetic valve (open state) of an example embodiment of the present disclosure.

FIG. 2 is a diagram illustrating an example of a use state of the electromagnetic valve (closed state) of an example embodiment of the present disclosure.

FIG. 3 is a sectional view illustrating a first example embodiment of the electromagnetic valve of the present disclosure.

FIG. 4 is an enlarged view (closed state) of a region [A] surrounded by a two-dot chain line in FIG. 3.

FIG. 5 is an enlarged view (open state) of the region [A] surrounded by the two-dot chain line in FIG. 3.

FIG. 6 is an enlarged view (closed state) of a region [B] surrounded by a two-dot chain line in FIG. 3.

FIG. 7 is an enlarged view (open state) of the region [B] surrounded by the two-dot chain line in FIG. 3.

FIG. 8 is a sectional view illustrating a second example embodiment of the electromagnetic valve of the present disclosure.

### DETAILED DESCRIPTION

Hereinafter, electromagnetic valves according to example embodiments of the present disclosure will be described in detail with reference to the accompanying drawings.

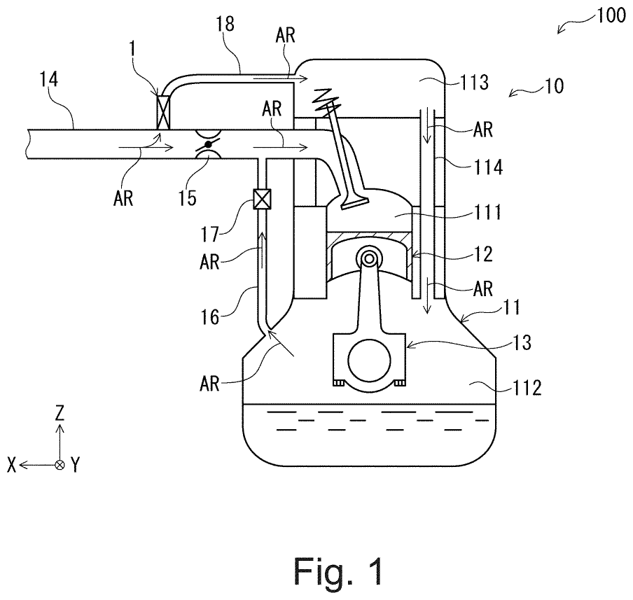

With reference to FIGS. 1 to 7, a first example embodiment of the electromagnetic valve of the present disclosure will be described. In the following description, for convenience of explanation, three axes orthogonal to each other are set as an X-axis, a Y-axis, and a Z-axis. As an example, an XY-plane including the X-axis and the Y-axis is horizontal, and the Z-axis is vertical. A direction parallel to the Z-axis may be referred to as an “axial direction (axis O1 direction)”, a radial direction centered on this axis may be simply referred to as a “radial direction”, and a circumferential direction centered on the axis may be simply referred to as a “circumferential direction”. Additionally, a negative side in a Z-axis direction may be referred to as “one axial side” or simply as “one side”, and a positive side in the Z-axis direction may be referred to as “the other axial side” or simply as “the other side”. In the present specification, a vertical direction, a horizontal direction, an upper side, and a lower side are simply names for describing a relative positional relationship of each part, and thus an actual placement relationship or the like may be a placement relationship or the like other than the placement relationship or the like indicated by these names.

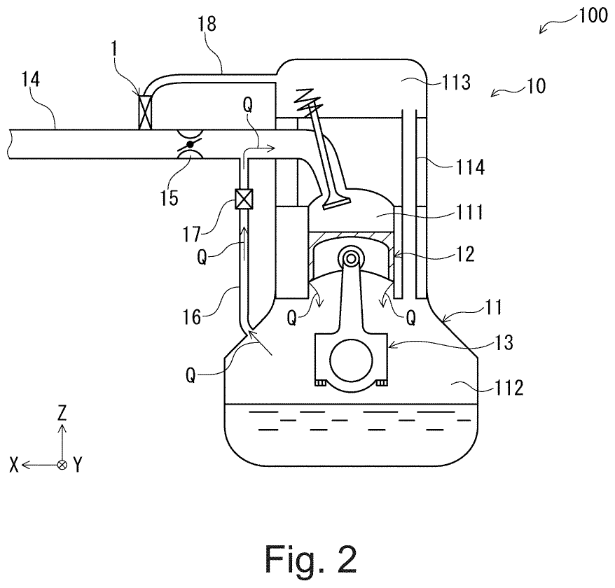

As illustrated in FIGS. 1 and 2, an electromagnetic valve 1 is used by being mounted on a vehicle 100 including an internal combustion engine 10 such as an engine, for example. The internal combustion engine 10 includes a housing 11 having a combustion chamber 111, a crank chamber 112, and a buffer chamber 113, a piston 12 movably provided in the combustion chamber 111, and a crank 13 provided in the crank chamber 112 to convert reciprocating motion of the piston 12 into rotational motion.

In the housing 11, the crank chamber 112 and the buffer chamber 113 are connected using an internal flow path 114.

To the combustion chamber 111, an external flow path 14 is connected from outside the housing 11. The external flow path 14 is provided midway with an electromagnetic valve 15 that is a throttle valve.

The external flow path 14 has a downstream side from the electromagnetic valve 15, being connected to the crank chamber 112 using a first auxiliary flow path 16. The first auxiliary flow path 16 is provided midway with an electromagnetic valve 17 that is a PCV valve.

The external flow path 14 has an upstream side from the electromagnetic valve 15, being connected to the buffer chamber 113 using a second auxiliary flow path 18. The second auxiliary flow path 18 is provided with the electromagnetic valve 1 of the present disclosure at a boundary portion between the external flow path 14 and the second auxiliary flow passage 18. The electromagnetic valve 1 switches opening and closing of the external flow path 14. The electromagnetic valve 1 causes the external flow path 14 (see FIG. 1) to be an open state during normal traveling of the vehicle 100, and causes the external flow path 14 (see FIG. 2) to be a closed state during leak detection for detecting a leak of a gaseous mixture AR or the like (hereinafter, simply referred to as a “leak”).

As illustrated in FIG. 1, the open state allows the gaseous mixture AR to pass through the external flow path 14 to flow into the combustion chamber 111, and then the gaseous mixture AR is subjected to combustion. This enables the piston 12 to move. A part of the gaseous mixture AR passing through the external flow path 14 flows into the second auxiliary flow path 18 from the middle of the external flow path 14, and sequentially passes through the buffer chamber 113 and the internal flow path 114 to reach the crank chamber 112. The gaseous mixture AR having flowed into the crank chamber 112 can return to the external flow path 14 through the first auxiliary flow path 16.

As illustrated in FIG. 2, the closed state allows supply of the gaseous mixture AR to the internal combustion engine 10 to be stopped. When the combustion chamber 111 has high pressure due to combustion, a part of a blow-by gas Q in the combustion chamber 111 passes through the piston 12 to flow into the crank chamber 112. After that, the blow-by gas Q in the crank chamber 112 flows into the external flow path 14 through the first auxiliary flow path 16. At this time, when no leakage occurs, pressure in the crank chamber 112 decreases with time. When the pressure in the crank chamber 112 falls below a threshold value, it is determined that no leak has occurred. In contrast, when leakage occurs, the pressure in the crank chamber 112 does not decrease to be prevented from falling below the threshold value, or the pressure is likely to decrease gently to take time to fall below the threshold value. In this case, it is determined that leakage has occurred.

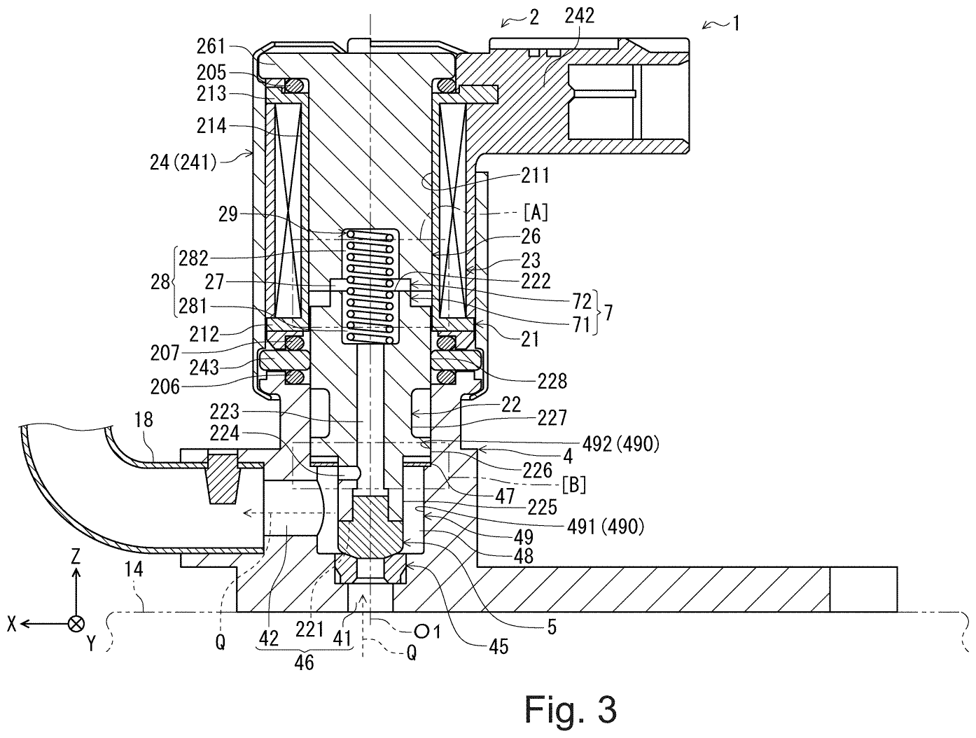

As illustrated in FIG. 3, the electromagnetic valve 1 includes a solenoid 2, a flow path assembly 4, and a valve element 5. Hereinafter, a configuration of each unit will be described.

The solenoid 2 includes a bobbin 21, a plunger 22, a coil 23, a case 24, a yoke 26, and a spring 29.

The bobbin 21 is a tubular member provided with a through-hole 211. The through-hole 211 passes through the bobbin 21 along the axis O1 direction parallel to the Z-axis direction. The through-hole 211 has an inner diameter that is constant along the axis O1 direction. The bobbin 21 is provided on one side in the axis O1 direction with a flange 212 protruding in the radial direction and on the other side in the axis O1 direction with a flange 213 protruding in the radial direction. The bobbin 21 is made of, for example, various kinds of resin material, such as a polyester resin and a polyimide resin.

The bobbin 21 has an outer peripheral portion 214 around which the coil 23 having conductivity is wound. When the coil 23 is brought into an energized state, or when the coil 23 is energized, a magnetic circuit is formed by the bobbin 21 and the yoke 26 to generate a magnetic force. This enables the plunger 22 to be moved along the axis O1 direction.

The plunger 22 is inserted into the through-hole 211 of the bobbin 21 on the one side in the axis O1 direction, and the yoke 26 is inserted thereinto on the other side in the axis O1 direction. A magnitude relationship between a proportion occupied by the plunger 22 (the amount of insertion of the plunger 22) and a proportion occupied by the yoke 26 (the amount of insertion of the yoke 26) in the through-hole 211 of the bobbin 21 is not particularly limited. Although in the configuration illustrated in FIG. 3, the latter is larger than the former, the present disclosure is not limited thereto. For example, the latter may be smaller than the former, or the former may be equal to the latter.

The yoke 26 is fixed to the bobbin 21. The yoke 26 has a columnar shape and is disposed parallel to the Z-axis direction. The yoke 26 is provided on the other side in the axis O1 direction with a flange 261 protruding in the radial direction. As a constituent material of the yoke 26, for example, a soft magnetic material such as iron, or a soft magnetic metal material can be used. This enables generating a magnetic circuit in a level allowing the plunger 22 to be sufficiently moved. The yoke 26 may be referred to as a “core”.

The solenoid 2 includes a gasket 205 disposed between the flange 213 of the bobbin 21 and the flange 261 of the yoke 26. The gasket 205 has a ring shape, and is disposed radially outward of the yoke 26 to be concentric with the yoke 26. The gasket 205 is compressed between the flange 213 of the bobbin 21 and the flange 261 of the yoke 26. As a constituent material of the gasket 205, for example, an elastic material can be used, and in particular, various rubber materials such as urethane rubber and silicone rubber are preferable.

The plunger 22 is supported to be alternately movable to the one side and the other side in the axis O1 direction along the axis O1 direction, or to be able to reciprocate along the axis O1 direction. The plunger 22 has a columnar shape and is disposed parallel to the Z-axis direction. The plunger 22 is disposed coaxially with the yoke 26, or about the axis O1 together with the yoke 26.

The plunger 22 changes in outer diameter, and includes a first small diameter portion 225, a first large diameter portion 226, a second small diameter portion 227, and a second large diameter portion 228, which are provided in order from the one side to the other side in the axis O1 direction.

The first small diameter portion 225 has an outer diameter that is constant along the axis O1 direction.

The first large diameter portion 226 has an outer diameter that is larger than the outer diameter of the first small diameter portion 225 and is constant along the axis O1 direction.

The second small diameter portion 227 has an outer diameter that is intermediate between the outer diameter of the first small diameter portion 225 and the outer diameter of the first large diameter portion 226, and that is constant along the axis O1 direction.

The second large diameter portion 228 has an outer diameter that is equal to the outer diameter of the first large diameter portion 226, and that is constant along the axis O1 direction. When the plunger 22 moves along the axis O1 direction, the second large diameter portion 228 slides in the bobbin 21.

The spring 29 is provided between the plunger 22 and the yoke 26. The spring 29 is a pressing surface that presses the plunger 22 toward the one side in the axis O1 direction. As the spring 29, for example, a coil spring is preferably used. This enables the spring 29 to be disposed concentrically with the axis O1 between the plunger 22 and the yoke 26, and to be compressed. Thus, the spring 29 can stably press the plunger 22 without excess or deficiency.

The case 24 houses the bobbin 21, the coil 23, and the yoke 26. The case 24 includes a case body 241, a connector member 242, and a ring member 243.

The case body 241 has a tubular shape, and is deformed by caulking on the one side and the other side in the axis O1 direction. This enables the case body 241 to be coupled and fixed to the flow path assembly 4 on the one side in the axis O1 direction. This also enables bringing the case body 241 into contact with the flange 261 of the yoke 26 to regulate a position of the yoke 26 on the other side in the axis O1 direction, or to prevent detachment of the yoke 26 from the case body 241 (prevention of detachment).

The ring member 243 has an annular shape, and is disposed radially outward of the plunger 22 to be concentric with the plunger 22.

The gasket 206 is in contact with the ring member 243 from the one side in the axis O1 direction while being compressed, and the gasket 207 is in contact with the ring member 243 from the other side in the axis O1 direction while being compressed. The gasket 206 and the gasket 207 each have a ring shape, and are disposed radially outward of the yoke 26 to be concentric with the yoke 26, as with the ring member 243. This enables maintaining airtightness in the solenoid 2 together with the gasket 205. As a constituent material of the gasket 206 and the gasket 207, for example, an elastic material can be used as with the gasket 205.

As a constituent material of the case body 241 and the ring member 243, a soft magnetic metal material such as iron can be used as with the yoke 26.

The connector member 242 is connected to a connector (not illustrated) used for energizing the coil 23.

The flow path assembly 4 is coupled to the solenoid 2 on the one side in the axis O1 direction. The flow path assembly 4 is provided inside with a fluid passage flow path 46 through which the blow-by gas Q, which is a fluid, can pass, and a valve element housing portion 49 communicating with the fluid passage flow path 46. As with the bobbin 21, the flow path assembly 4 is made of, for example, a resin material.

The fluid passage flow path 46 includes a first flow path 41 and a second flow path 42.

The first flow path 41 is provided along the axis O1 direction, or the Z-axis direction, and opens toward the negative side in the Z-axis direction. The first flow path 41 is connected to the external flow path 14 to communicate with the combustion chamber 111 through the external flow path 14.

The second flow path 42 is provided along the X-axis direction and opens toward the positive side in the X-axis direction. The second flow path 42 is connected to the second auxiliary flow path 18.

The valve element housing portion 49 has a tubular space 48 communicating with the first flow path 41 and the second flow path 42. The tubular space 48 is provided on an extension line of the first flow path 41, or along the axis O1 direction. The valve element 5 is housed in the tubular space 48 to be movable along the axis O1 direction (Z-axis direction) together with the plunger 22.

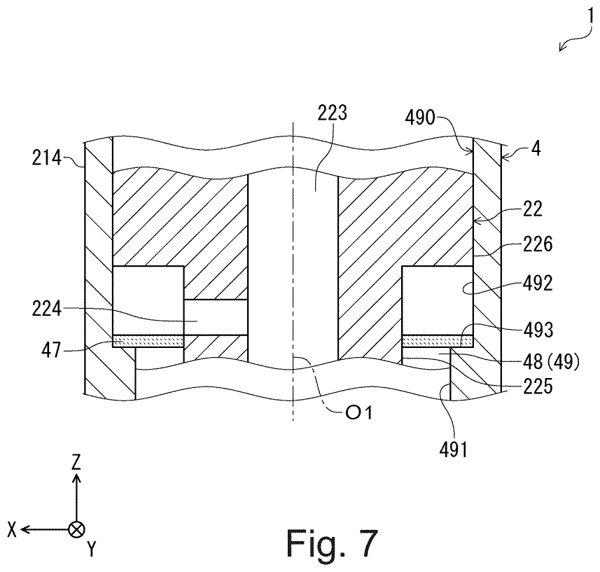

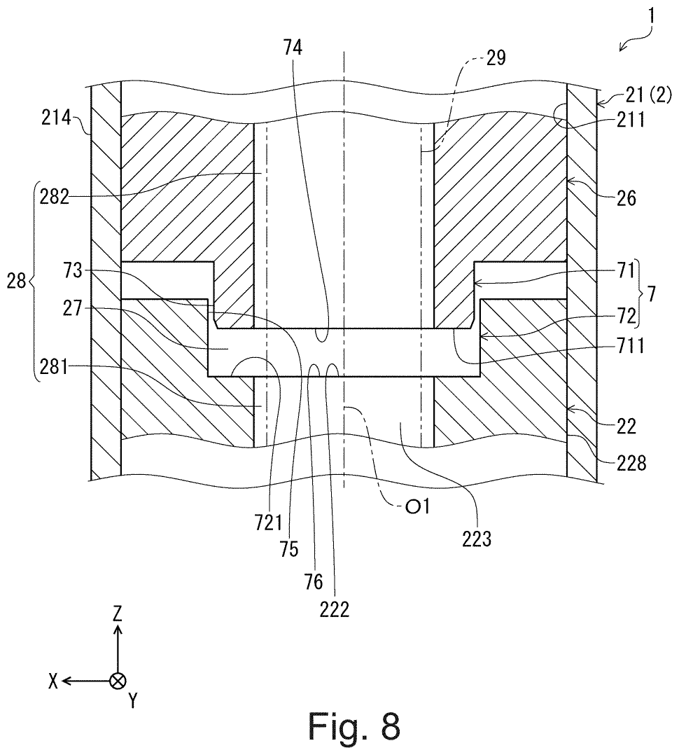

As illustrated in FIGS. 7 and 8, the valve element housing portion 49 includes an inner peripheral portion 490 provided with a reduced diameter portion 491 having a reduced inner diameter and an increased diameter portion 492 having an increased inner diameter. The reduced diameter portion 491 is located on the one side in the axis O1 direction in the inner peripheral portion 490, and the increased diameter portion 492 is located on the other side in the axis O1 direction in the inner peripheral portion 490.

The first flow path 41 is connected to the reduced diameter portion 491 from the negative side in the Z-axis direction, and the second flow path 42 is connected to the reduced diameter portion 491 from the negative side in the X-axis direction.

In the increased diameter portion 492, when the plunger 22 moves along the axis O1 direction, the first large diameter portion 226 and the second large diameter portion 228 of the plunger 22 slide. This allows the plunger 2 to be guided by the increased diameter portion 492, so that the plunger 2 can move stably.

Then, a partition portion 47 is provided on a stepped portion 493 being a boundary portion between the reduced diameter portion 491 and the increased diameter portion 492. This enables the tubular space 48 to be partitioned into two spaces along the axis O1 direction.

As described above, the valve element 5 is movably housed in the tubular space 48 together with the plunger 22. Movement of the valve element 5 enables switching between the open state and the closed state in the middle of the fluid passage flow path 46, or between the first flow path 41 and the second flow path 42.

The open state enables passage of the blow-by gas Q in the fluid passage flow path 46. For example, when the internal combustion engine 10 equipped with the electromagnetic valve 1 is a natural intake type engine, the blow-by gas Q flows from the first flow path 41 toward the second flow path 42 through the tubular space 48.

In contrast, the closed state blocks the passage of the blow-by gas Q in the fluid passage flow path 46. FIG. 3 illustrates the closed state.

As illustrated in FIG. 3, the valve element 5 is fixed to the plunger 22 on the one side in the axis O1 direction. As the valve element 5 moves together with the plunger 22, the valve element 5 can approach the first flow path 41 to close the first flow path 41, and can separate from the first flow path 41 to open the first flow path 41. This switches between the open state and the closed state.

In the present example embodiment, the valve element 5 can move toward the one side in the axis O1 direction by being pressed together with the plunger 22 by the spring 29 while the energized state for the coil 23 is released. This enables the valve element 5 to approach the first flow path 41 to close the first flow path 41 to form a closed state.

In contrast, in the energized state, the coil 23 generates a magnetic force, so that the valve element 5 can move toward the other side in the axis O1 direction together with the plunger 22 against a pressing force of the spring 29. This enables the valve element 5 to be separated from the first flow path 41 to open the first flow path 41 to form an open state.

The valve element 5 has, for example, a columnar or plate-like shape. The valve element 5 has a maximum outer diameter that is equal to the outer diameter of the first small diameter portion 225 of the plunger 22. This prevents the valve element 5 from coming into contact with the reduced diameter portion 491 of the valve element housing portion 49, so that movement of the plunger 22 and the valve element 5 itself can be prevented from being hindered by the valve element 5.

As with the gasket 205, the valve element 5 is made of, for example, an elastic material.

The flow path assembly 4 includes a valve seat 45 provided in the first flow path 41. The valve seat 45 is a ring-shaped member disposed concentrically with the first flow path 41, and is made of, for example, an elastic material similar to that of the valve element 5. As a result, as illustrated in FIG. 3, the valve element 5 and the valve seat 45 can be brought into close contact with each other in the closed state, and the passage of the blow-by gas Q in the fluid passage flow path 46 can be sufficiently blocked.

As described above, the valve element 5 is fixed to the plunger 22 on the one side in the axis O1 direction. The plunger 22 includes a passage 223 that extends along the axis O1 and an opening 224 that opens radially outward from the passage 223.

The passage 223 includes a leading end opening 221 that opens toward the one side in the axis O1 direction and a proximal end opening 222 that opens toward the other side in the axis O1 direction. The valve element 5 is fitted and fixed to the leading end opening portion 221. This seals the passage 223 on one side. The passage 223 communicates with a gap 27 between the plunger 22 and the yoke 26 through the proximal end opening 222.

The opening 224 is a side hole passing through the plunger 22 in the radial direction, or in the X-axis direction, and communicates with the gap 27 through the passage 223.

The blow-by gas Q may contain impurities such as dust called contamination. The blow-by gas Q can pass through from the fluid passage flow path 46 to the gap 27 through the opening 224 and the passage 223 in order. When the blow-by gas Q contains impurities, the impurities may enter between the bobbin 21 and the plunger 22 when the blow-by gas Q reaches the gap 27. The impurities having entered between the bobbin 21 and the plunger 22 hinder smooth movement of the plunger 22, or cause a decrease in sliding performance of the plunger 22.

Thus, the electromagnetic valve 1 has a structure for preventing intrusion of impurities. Hereinafter, the structure for preventing intrusion of impurities will be described.

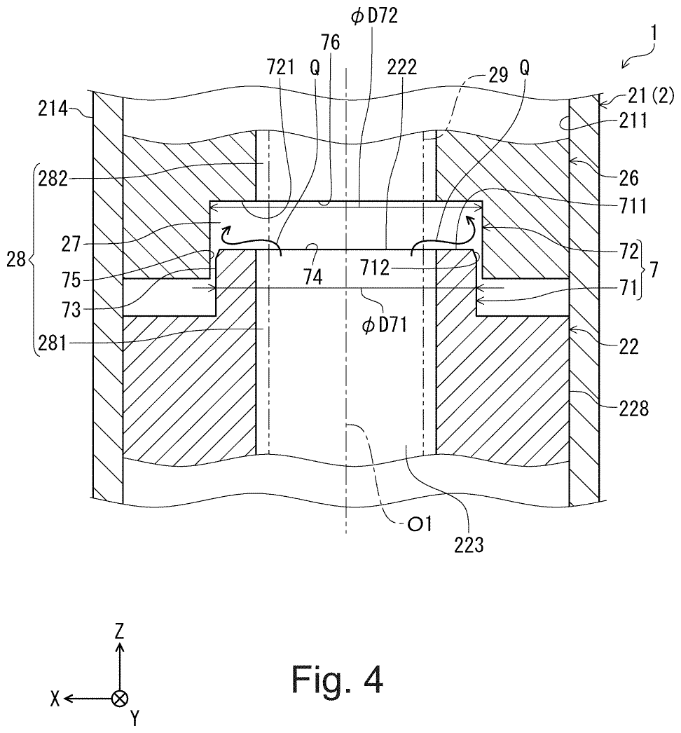

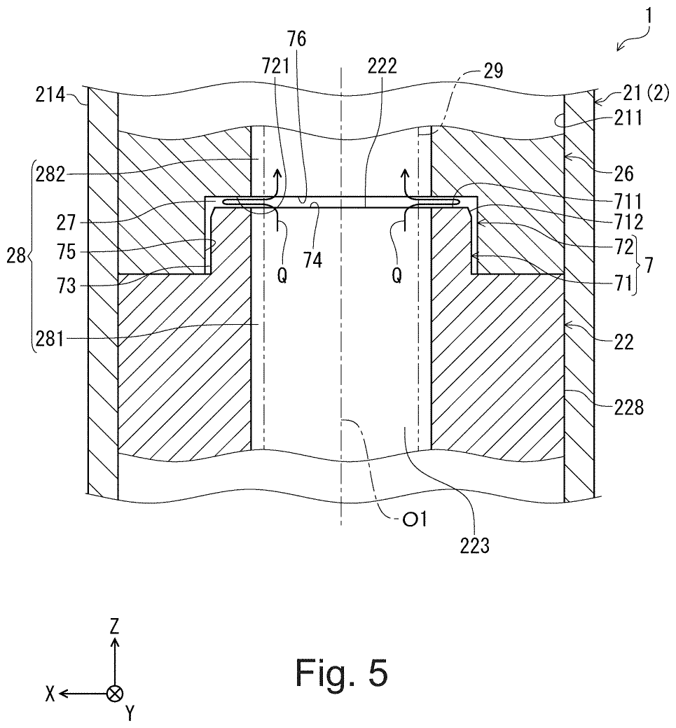

As illustrated in FIGS. 4 and 5, the electromagnetic valve 1 includes a regulating portion 7 as a structure for preventing intrusion of pure substances. The regulating portion 7 can regulate a radially outward flow of the blow-by gas Q (fluid) having flowed out to the gap 27 from the passage 223 through the proximal end opening 222 in the open state and the closed state.

The regulating portion 7 has a protrusion 71 and a recess 72 positioned about the axis O1.

The protrusion 71 is provided protruding toward the other end side in the axis O1 direction of the plunger 22. The protrusion 71 has an outer diameter φD71 that is constant along the axis O1 direction except for a chamfered portion 712. The protrusion 71 has a top portion 711 in which the proximal end opening 222 of the passage 223 opens. This enables the blow-by gas Q to flow into the gap 27.

The recess 72 is provided in the yoke 26 while being recessed toward the one side in the axis O1 direction. The recess 72 has an inner diameter φD72 that is constant along the axis O1 direction. The inner diameter φD72 of the recess 72 is larger than the outer diameter φD71 of the protrusion 71. This enables the protrusion 71 to easily enter the recess 72.

Satisfying a relationship in which the inner diameter φD72 is larger than the outer diameter φD71 allows the protrusion 71 and the recess 72 to be separated from each other in the radial direction. The protrusion 71 includes a first surface 73 facing the recess 72 in the radial direction and a second surface 74 facing the recess 72 in the axis O1 direction. In contrast, the recess 72 includes a third surface 75 facing the protrusion 71 (first surface 73) in the radial direction and a fourth surface 76 facing the protrusion 71 (second surface 74) in the axis O1 direction. Thus, the regulating portion 7 has four surfaces each facing the radial direction or the axis O1 direction. In particular, between the first surface 73 and the third surface 75 facing each other in the radial direction of these four surfaces, a flow of the blow-by gas Q can be narrowed. This enables regulating a forward flow of the blow-by gas Q from between the first surface 73 and the third surface 75, or a radially outward flow thereof.

The regulating portion 7 configured as described above prevents impurities contained in the blow-by gas Q from entering between the bobbin 21 and the plunger 22 through the gap 27. This enables preventing smooth movement of the plunger 22 from being hindered by impurities, or the sliding performance of the plunger 22 from being deteriorated.

Although a difference between the inner diameter φp72 and the outer diameter φp71 is not particularly limited, the difference is preferably smaller than a mean particle diameter of impurities, for example. This enables a radially outward flow of the blow-by gas Q containing impurities to be regulated without excess or deficiency.

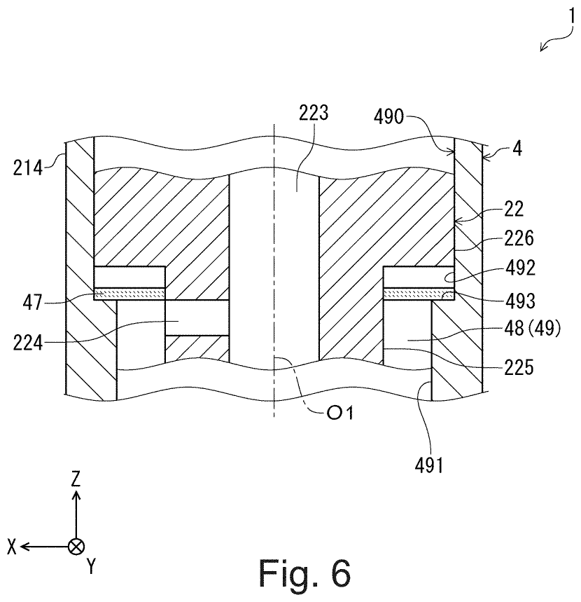

The opening 224 is located on the one side in the axis O1 direction with respect to the partition portion 47 in the closed state (see FIG. 6), and is located on the other side in the axis O1 direction with respect to the partition portion 47 in the open state (see FIG. 7). This enables reducing a flow of the blow-by gas Q in the fluid passage flow path 46 to the gap 27 through the opening 224 and the passage 223 at least in the open state, thereby contributing to prevention of intrusion of impurities.

As illustrated in FIG. 3, the electromagnetic valve 1 includes a spring housing portion (pressing surface housing portion) 28 that houses the spring 29. The spring housing portion 28 is provided across the plunger 22 and the yoke 26, and includes an increased diameter portion 281 that is increased in diameter in the passage 223 on the other side in the axis O1 direction, and a recess 282 that is recessed from an end surface of the yoke 26 on the one side in the axis O1 direction. This brings the spring 29 into contact with not only a bottom surface of the increased diameter portion 281 on the one side in the axis O1 direction, but also a bottom surface (top surface) of the recess 282 on the other side in the axis O1 direction, so that the spring 29 is sufficiently compressed to be able to stably press the plunger 22.

When the blow-by gas Q having passed through the passage 223 flows into the increased diameter portion 281, the blow-by gas Q is reduced in flow velocity. This prevents the blow-by gas Q from vigorously flowing into the gap 27, thus contributing to prevention of intrusion of impurities from the gap 27 into between the bobbin 21 and the plunger 22. As described above, the increased diameter portion 281 functions as a buffer portion that reduces the flow velocity of the blow-by gas Q.

The passage 223 can also serve as a part of the spring housing portion 28, thus contributing to downsizing of the electromagnetic valve 1. The spring housing portion 28 may be provided in a portion different from the passage 223 without communicating with the passage 223.

Although a second example embodiment of the electromagnetic valve of the present disclosure will be described below with reference to FIG. 8, differences from the above-described example embodiment will be mainly described, and duplicated description of similar matters will be eliminated.

The present example embodiment is similar to the first example embodiment except for a difference in a positional relationship between the protrusion and the recess constituting the regulating portion, or in a placement place of each of the protrusion and the recess.

As illustrated in FIG. 8, in the present example embodiment, the protrusion 71 is provided protruding from the yoke 26 on the one side in the axis O1 direction. The recess 72 is provided in the plunger 22 while being recessed toward the other end side in the axis O1 direction. The recess 72 has a bottom portion 721 in which the proximal end opening 222 of the passage 223 opens. This enables the blow-by gas Q to flow into the gap 27.

As with the first example embodiment, the regulating portion 7 configured as described above can also prevent impurities contained in the blow-by gas Q from entering between the bobbin 21 and the plunger 22 through the gap 27. This enables preventing smooth movement of the plunger 22 from being hindered by impurities.

Depending on the shape (total length) of the plunger 22 or the yoke 26, for example, it may be preferable to provide the protrusion 71 on the yoke 26 and to provide the recess 72 on the plunger 22. The configuration of the present example embodiment is suitable for such a case.

Although the electromagnetic valve of the present disclosure is described with reference to the illustrated example embodiment, the present disclosure is not limited thereto, and each part constituting the electromagnetic valve can be replaced with a part having any configuration capable of exhibiting similar functions. Additionally, an arbitrary component may be added.

The electromagnetic valve of the present disclosure may be configured such that any two or more structures (features) of each of the example embodiments described above are combined.

Although the electromagnetic valve 1 is mounted and used in the vehicle 100 equipped with the internal combustion engine 10 such as an engine in each of the example embodiments described above, the application place of the electromagnetic valve is not limited to the vehicle 100. The fluid that is switched between passage and interruption by the electromagnetic valve 1 is not limited to the gas (blow-by gas Q), and may be a liquid or a mixture of gas and liquid.

Although the electromagnetic valve 1 is configured to allow the blow-by gas Q to flow from the first flow path 41 toward the second flow path 42 in each of the example embodiments described above, the blow-by gas Q is also allowed to flow from the second flow path 42 toward the first flow path 41 depending on a use state of the electromagnetic valve 1.

Although the regulating portion 7 in each of the example embodiments described above regulates a flow of the blow-by gas Q in each of the open state and the closed state, the present disclosure is not limited thereto. The regulating portion 7 may regulate the flow of the blow-by gas Q at least in the open state.

Although the regulating portion 7 in the example embodiments described above has four surfaces each facing the radial direction or the axis O1 direction, the present disclosure is not limited thereto, and the surface facing the axis O1 direction may be eliminated. When the surface facing the axis O1 direction is eliminated, the regulating portion 7 may include at least one of the protrusion 71 and the recess 72 that has a curved surface or the like obtained by rotating a conical surface, a pyramidal surface, or a parabola about the axis O1, for example.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electromagnetic valve comprising:
a solenoid including:
a bobbin with a tubular shape including a through-hole passing through the bobbin along an axial direction;
a plunger that is inserted in the through-hole on one axial side, and that is movably supported along the axial direction;
a yoke that is inserted in the through-hole on another axial side, and that is fixed to the bobbin; and
a coil that is wound around an outer peripheral portion of the bobbin to generate a magnetic force with energization to move the plunger in the axial direction; and
a flow path assembly including:
a first flow path;
a second flow path; and
a valve housing portion provided with a tubular space communicating with the first flow path and the second flow path; wherein
the flow path assembly is coupled to the solenoid; and
a valve housed in the valve housing portion and fixed to the plunger on the one axial side, and moves together with the plunger along the axial direction to switch between an open state and a closed state between the first flow path and the second flow path;
the plunger includes:
a passage that extends along the axial direction and opens toward the another axial side, and that communicates with a gap between the plunger and the yoke; and
an opening that opens radially outward from the passage and communicates with the gap through the passage; and
the electromagnetic valve further includes a regulator to regulate a radially outward flow of a fluid flowing out from the passage to the gap at least in the open state.

2. The electromagnetic valve according to claim 1, wherein the regulator regulates the radially outward flow of the fluid flowing out from the passage to the gap even in the closed state.

3. The electromagnetic valve according to claim 1, wherein the regulator includes a surface opposing at least a radial direction which is perpendicular or substantially perpendicular to the axial direction.

4. The electromagnetic valve according to claim 1, wherein the regulator includes a protrusion provided protruding on the yoke on the one axial side or on the plunger on the another axial end side, and a recess opposing the protrusion and into which the protrusion is fitted.

5. The electromagnetic valve according to claim 4, wherein the protrusion and the recess are separated from each other in a radial direction which is perpendicular or substantially perpendicular to the axial direction.

6. The electromagnetic valve according to claim 4, wherein the protrusion is provided on the plunger, and the recess is provided in the yoke.

7. The electromagnetic valve according to claim 6, wherein the passage opens at a top portion of the protrusion on the another axial side.

8. The electromagnetic valve according to claim 4, wherein the recess is provided in the plunger, and the protrusion is provided on the yoke.

9. The electromagnetic valve according to claim 8, wherein the passage opens at a bottom portion of the recess on the another axial side.

10. The electromagnetic valve according to claim 6, wherein the recess includes an inner diameter that is larger than an outer diameter of the protrusion.

11. The electromagnetic valve according to claim 1, further comprising a pressing surface between the plunger and the yoke to press the plunger along the axial direction together with the valve.

12. The electromagnetic valve according to claim 11, further comprising a pressing surface housing portion extending across the plunger and the yoke to house the pressing surface.

13. The electromagnetic valve according to claim 12, wherein the pressing surface housing portion includes an increased diameter portion including an increased diameter portion of the passage.

14. The electromagnetic valve according to claim 1, wherein
the flow path assembly further includes a partition to partition the tubular space in the axial direction; and
the opening is located on the one axial side with respect to the partition in the closed state, and is located on the another axial side with respect to the partition in the open state.
